(19) United States
(12) Patent Application Publication
(10) Pub. No.: US 2024/0020171 A1
(43) Pub. Date: Jan. 18, 2024

(54) RESOURCE AND WORKLOAD SCHEDULING

(71) Applicant: INTERNATIONAL BUSINESS MACHINES CORPORATION, ARMONK, NY (US)

(72) Inventors: Le Yao, Xian (CN); Geng Hu, Xi'an City (CN); DONG PING SONG, Xi'an (CN); Wei Xian, Xi'an (CN); Madeline Ma, Xian (CN); Zhan Wei Wang, Xi'an (CN)

(21) Appl. No.: 17/811,895

(22) Filed: Jul. 12, 2022

(51) Int. Cl. G06F 9/50; G06F 9/48

(52) U.S. Cl. CPC G06F 9/505; G06F 9/4881

(57) ABSTRACT

A method, computer system, and a computer program product for workload scheduling is provided. The present invention may include determining a spare resource on each of a plurality of hosts for a plurality of workloads. The present invention may include obtaining an average resource consumption on the plurality of hosts based on a historical resource consumption association with the plurality of workloads. The present invention may include determining a boost action based on the spare resource and the average resource consumption, the boost action comprising a number of tasks among the plurality of tasks assigned to a respective one of the plurality of hosts. The present invention may include dispatching the number of tasks to the respective one of the plurality of hosts based on the boost action.

### BACKGROUND

The present disclosure relates generally to the field of computing, and more particularly to workload scheduling.

A popular way of distributing computing resources on High Performance Computing (HPC) cluster may be to use a resource plan for assigning resources to the workloads. However, the resource plan may be predefined by customers based on their experiences, which may not match the actual resource consumption. Therefore, the resource plan may waste resources when there are pending workloads in the cluster.

Customers may optimize the resource plan by observing and monitoring their cluster health data, however, this may lead to inaccuracies and may be an inefficient means of optimizing a resource plan.

### SUMMARY

Embodiments of the present invention disclose a method, computer system, and a computer program product for workload scheduling. The present invention may include determining a spare resource on each of a plurality of hosts for a plurality of workloads. The present invention may include obtaining an average resource consumption on the plurality of hosts based on a historical resource consumption association with the plurality of workloads. The present invention may include determining a boost action based on the spare resource and the average resource consumption, the boost action comprising a number of tasks among the plurality of tasks assigned to a respective one of the plurality of hosts. The present invention may include dispatching the number of tasks to the respective one of the plurality of hosts based on the boost action.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts a cloud computing node according to an embodiment of the present disclosure.

FIG. 2 depicts a cloud computing environment according to an embodiment of the present disclosure.

FIG. 3 depicts abstraction model layers according to an embodiment of the present disclosure.

FIG. 4 depicts an example system for resource and workload scheduling in accordance with some embodiments of the present disclosure.

FIG. 5 depicts an example method for resource and workload scheduling in accordance with some embodiments of the present disclosure.

FIG. 6 depicts an intelligent boost model for resource and workload scheduling in accordance with some embodiments of the present disclosure.

FIG. 7 depicts an example method 700 for the operations of the intelligent boost model 600 in accordance with some embodiments of the present disclosure.

FIG. 8 depicts an example method for resource and workload scheduling in accordance with some embodiments of the present disclosure.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

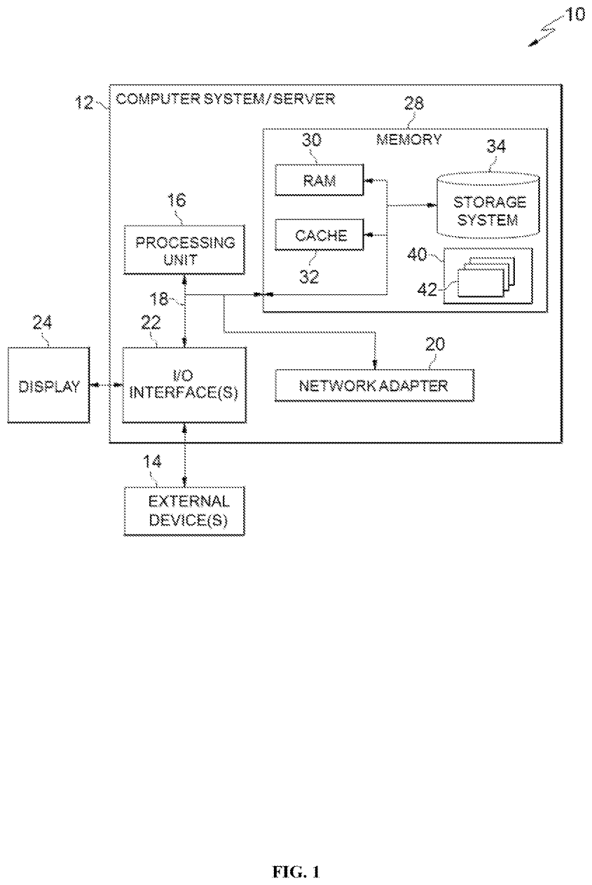

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12 or a portable electronic device such as a communication device, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

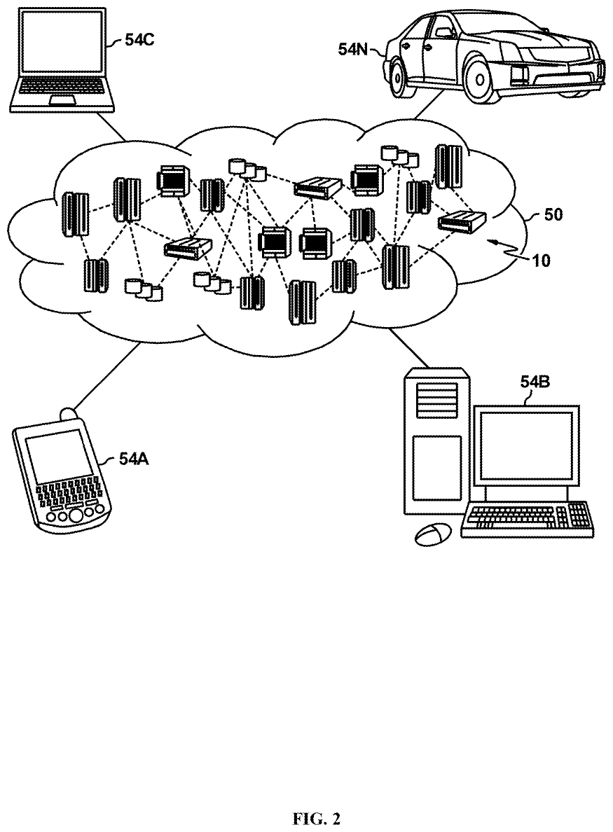

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

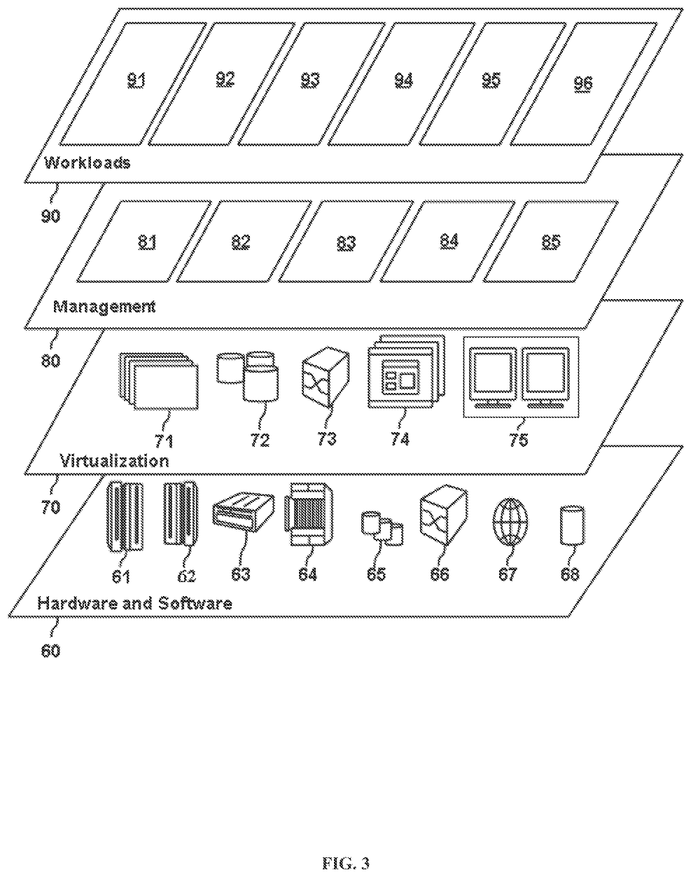

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and resource and workload scheduling 96.

In accordance with some embodiments of the present disclosure, when there are pending workloads in a cluster of hosts, the current resource consumption, and the spare resource on each of the hosts may be determined. Each workload may include a plurality of tasks and average resource consumption of each of the plurality of tasks in each workload on each host may be determined based on the historical data. The number of the tasks of each workload that can be run on a respective one of the hosts may be determined based on the spare resource and the average resource consumption. In this way, the resource and workload may be dynamically scheduled to exploit the computing resources on the cluster of hosts. Embodiments of the present disclosure will now be described with reference to the drawings.

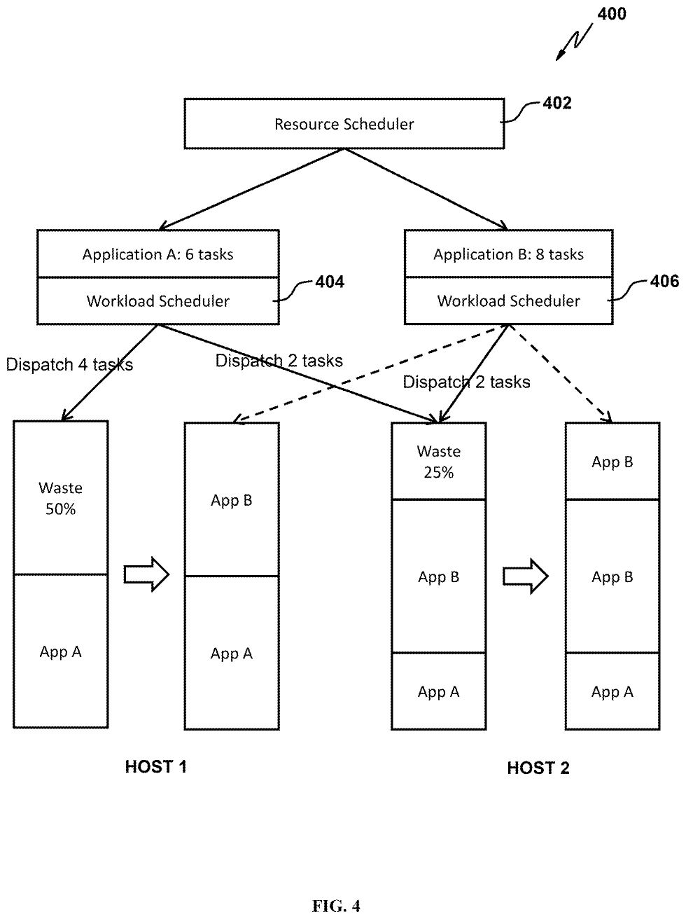

With reference now to FIG. 4, an example system 400 for resource and workload scheduling in accordance with some embodiments of the present disclosure is depicted. The resource may include a computing resource, a memory resource, and/or a storage resource. The resource scheduler 402 may implement a resource plan which may be predefined by customers. For example, the resource plan may assign one Central Processing Unit (CPU) core and 2 Gigabytes (G) memory to a task of a workload. Each workload or application may have a plurality of tasks. For example, Application A has 6 tasks and Application B has 8 tasks. In addition, a workload may have a higher priority than another workload. For example, Application A may have a higher priority than Application B. It is to be understood that there may be more than two workloads, although two workloads are illustrated in FIG. 4.

In this example, each of host 1 and host 2 may have a 4 core CPU and an 8G memory. The resources may be first assigned to Application A and then assigned to Application B, because Application A has a higher priority than Application B. In this case, the workload scheduler 404 may dispatch four tasks to host 1 and dispatch the remaining two tasks to host 2. The workload scheduler 406 may dispatch two tasks to host 2. The remaining six tasks of Application B may be waiting for execution. However, there may still a 50% waste on host 1 and a 25% on host 2. In this case, there may be a substantial resource waste on the hosts and the utilization of the resources may not be optimal.

In some embodiments, in order to mitigate the resource waste on the hosts, each host may determine the current resource consumption and the spare resource on the host. For example, each host may implement or instantiate a daemon, which may periodically determine the current resource consumption and the spare resource. In FIG. 4, each of host 1 and host 2 may implement a daemon to monitor the current resource consumption and the spare resource. The resource consumption may be saved in a data store for subsequent use. The application may run more than one time in the cluster and there are historical data about the resource consumption associated with the application. In this case, the average resource consumption may be calculated or otherwise determined based on the historical resource consumption data. For example, the historical resource consumption data may show that each of the tasks in Application A uses 0.5 CPU core and 1G memory and that each of the tasks in Application B uses one CPU core and 2G memory.

The spare resource and the historical resource consumption data may be used to determine a boost action. For example, resource scheduler 402 and/or the workload schedulers 404, 406 may determine the boost action based on the spare resource and historical resource consumption data associated with each host. The boost action may include the number of tasks assigned to the host, in other words, how many tasks that can be run on the spare resource. For example, the boost action may include the number of tasks for a type of workload or application that can be scheduled to a host. For example, the spare resource of host 1 is 2 CPU cores and 4G memory. All of the tasks in application A has been dispatched but 6 tasks in Application B are not dispatched. The historical resource consumption data shows that each task in Application B uses one CPU core and 2G memory. The spare resource in host 1 includes 2 CPU cores and 4G memory, and the spare resource in host 2 includes 1 CPU core and 2G memory. As a result, the workload scheduler 406 may assign 2 tasks of Application B to host 1 and assign 1 task of Application B to host 2. Then, the workload scheduler 406 may dispatch the number of tasks to the respective one of the plurality of hosts based on the boost action. In this case, all of the resources in both hosts can be sufficiently used.

It is to be understood that the workload schedulers 404 and 406 and the resource scheduler 402 may be implemented at one or more hosts, for example, host 1 and/or host 2, and the workload schedulers 404 and 406 and the resource scheduler 402 may be implemented at a separate node or even at a virtualized layer over the nodes or hosts.

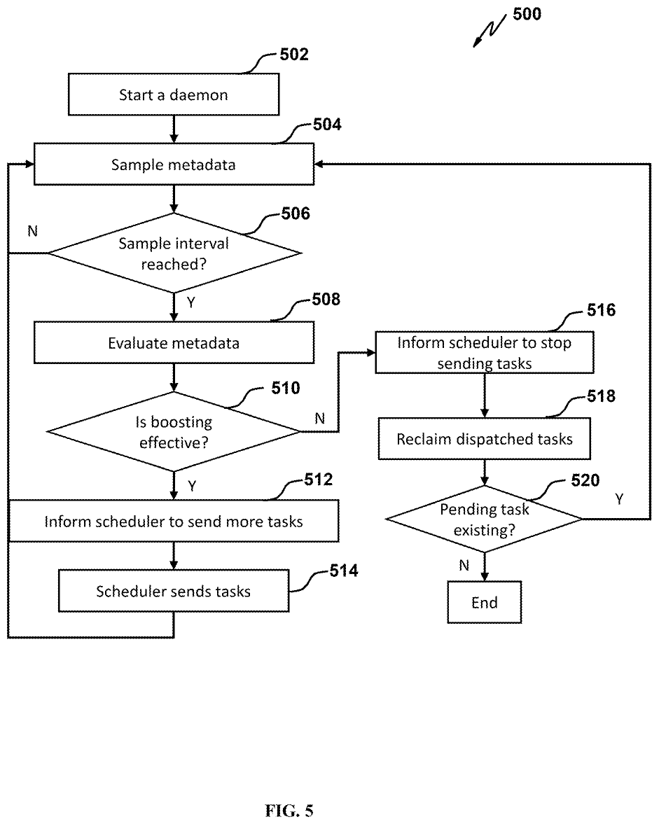

FIG. 5 depicts an example method 500 for resource and workload scheduling in accordance with some embodiments of the present disclosure. It is to be understood that the method 500 may be implemented at the system 400 in FIG. 4. At block 502, a host (for example, host 1 or host 2 in FIG. 4) may start a daemon configured to monitor or collect the metadata of the host. For example, the host may start the daemon when the resource and workload scheduling is needed. At block 504, the daemon may sample the metadata of the host. For example, the metadata may include the current resource consumption and the spare resource on the host. In particular, the current resource consumption may include the current resource consumption by each task or each application on the host.

At block 506, the daemon may determine whether the sample interval has been reached. If the sample interval has been reached, the method 500 will proceed to block 508, where the collected metadata will be evaluated. If the sample interval has not been reached, the method 500 will proceed to block 504 to continue to sample the metadata.

At block 508, one or more boost indicators may be calculated to evaluate the metadata. For example, a boost indicator may be the difference between the scheduled resource and the actual resource utilization. Another boost indicator may be the number of workloads completed per unit time, the number of applications completed per unit time, or the number of tasks completed per unit time.

At block 510, the host may determine whether the boost indictor is greater than a threshold to determine whether the boosting is effective. For example, if the boost indicator is the difference between the scheduled resource and the actual resource utilization, the host may determine whether the difference is greater than a threshold. If the difference is greater than the threshold, the host may determine that the boosting is effective; otherwise, the host may determine that the boosting is not effective. As another example, if the boost indicator is the number of workloads completed per unit time, the host may determine whether the number is greater than a threshold. If the number is greater than the threshold, the host may determine that the boosting is effective; otherwise, the host may determine that the boosting is not effective.

If it is determined at block 510 that the boosting is effective, the method 500 will proceed to block 512. At block 512, the host will send a message to the scheduler to inform the scheduler to send more tasks. At block 514, in response to receiving the message from the host, the scheduler may send one or more tasks to the host and the method 500 returns to block 504.

If it is determined at block 510 that the boosting is not effective, the method 500 will proceed to block 516. At block 516, the host will send a message to the scheduler to inform the scheduler to stop sending tasks to the host. At block 518, the scheduler will reclaim the dispatched tasks from the host.

At block 520, it is determined whether there is any pending task. If it is determined that there is a pending task, the method 500 will proceed to block 504; otherwise, the method 500 will terminate.

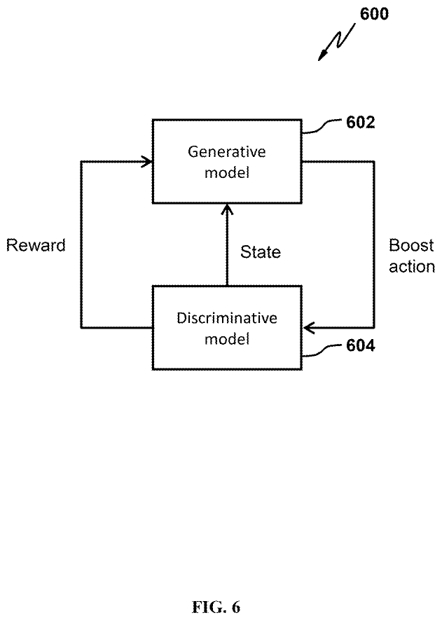

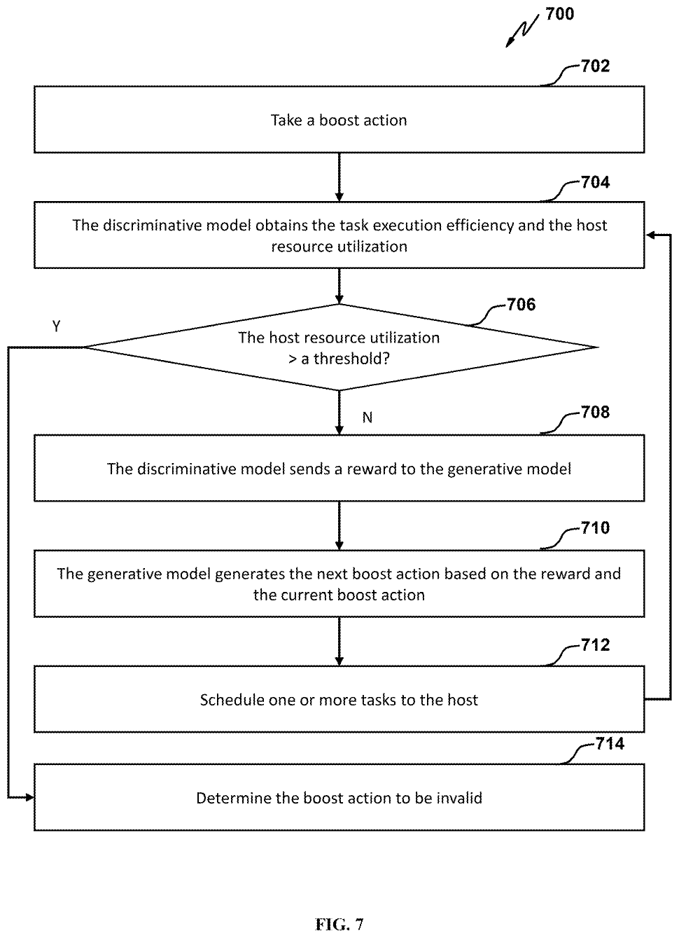

In some embodiments, an intelligent boost model 600 in accordance with some embodiments of the present disclosure is depicted in FIG. 6, which may improve the boost action. FIG. 7 depicts an example method 700 for the operations of the intelligent boost model 600 in accordance with some embodiments of the present disclosure. For example, the intelligent boost model 600 may use a reinforced learning model comprising a generative model 602 configured to generate boost actions and a discriminative model 604 configured to evaluate the boost actions. The input of the generative model 602 may include the name of the applications, the pending tasks, the spare resource on each host, the historical resource consumption on each host, and/or the host names. The output of the generative model 602 may include a boost action, which may include the number of tasks for a respective application on a respective one of the hosts. For example, 3 tasks for Application A are assigned to host 1.

At block 702, the system 400 may take a boost action, which may be determined by comparing the spare resource to the historical resource consumption. Each host may determine the task execution efficiency and the host resource utilization. For example, the task execution efficiency may be defined as the number of tasks completed per unit time and the host resource utilization may be defined as the utilization of the host resource.

At block 704, the discriminative model 604 may obtain the task execution efficiency and the host resource utilization for the boost action.

At block 706, the discriminative model 604 may determine whether a host resource utilization for the boost action is greater than a threshold (e.g., 90%). If it is determined that the host resource utilization is greater than the threshold, the method 700 will proceed to block 714, where the boost action will be determined to be invalid, and it will not trigger the boost action anymore. Otherwise, the discriminative model 604 may proceed to block 708.

At block 708, the discriminative model 604 may determine a reward based on at least one of the task execution efficiency and the host resource utilization and send the reward to the generative model 602. For example, the reward may include at least one of the task execution efficiency and the host resource utilization, or the reward may be a function of at least one of the task execution efficiency and the host resource utilization.

In some embodiments, the discriminative model 604 may determine the reward based on a change in the task execution efficiency after the boost action. For example, if the change in the task execution efficiency after the boost action is greater than a threshold, it may give a positive feedback as a reward to determine the next boost action. On the other hand, if the change in the task execution efficiency after the boost action is not greater than a threshold, it may give a negative feedback as a reward to determine the next boost action.

In some embodiments, the discriminative model 604 may determine the reward based on the change in the task execution efficiency after the boost action and the host resource utilization. If the change in the task execution efficiency is greater than its threshold, but the host resource utilization is less than its threshold, then it will be parsed that the boost action is an invalid boost action, and the next boost action could be changed or no next boost action will be required, depending on whether there is any pending task.

In some embodiments, if the change in the task execution efficiency is greater than a first threshold, but the host resource utilization keeps the same or keeps in a predefined range, it may give a positive feedback as a reward to determine the next boost action. If the change in the task execution efficiency is less than the first threshold, and the host resource utilization is less than the second threshold, it may give a negative feedback as the reward to determine the next boost action.

At block 710, the generative model 602 may determine a next boost action based on the reward with the current boost action as a state of the generative model 602. For example, the next boost action may include a second number of tasks for a respective application assigned to the respective one of the hosts. The generative model 602 may further receive as inputs the name of the applications, the pending tasks, the spare resource on each host, the historical resource consumption on each host, and/or the host names.

At block 712, the scheduler may schedule or dispatch the second number of tasks for the respective application to the host based on the next boost action. In response to the next boost action, the method 700 may proceed to block 704 to begin the next iteration. In this way, the intelligent boost model 500 may help iteratively improve the boost action, which may in turn improve the resource and task scheduling.

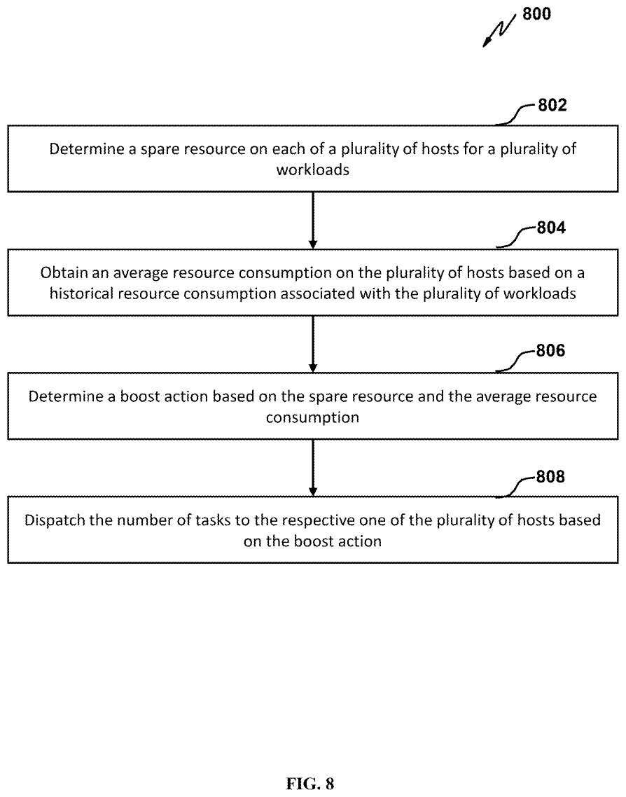

FIG. 8 depicts a flowchart illustrating an example method 800 for resource and workload scheduling in accordance with some embodiments of the present disclosure.

At block 802, the method 800 may determine a spare resource on each of a plurality of hosts for a plurality of workloads, each of the plurality of workloads comprising a plurality of tasks.

At block 804, the method 800 may obtain an average resource consumption on the plurality of hosts based on a historical resource consumption associated with the plurality of workloads.

At block 806, the method 800 may determine a boost action based on the spare resource and the average resource consumption, the boost action comprising a number of tasks among the plurality of tasks assigned to a respective one of the plurality of hosts.

At block 808, the method 800 may dispatch the number of tasks to the respective one of the plurality of hosts based on the boost action.

In some embodiments, the method 800 may further comprise determining a reward based on a change in a task execution efficiency after the boost action via a discriminative model; and determining a next boost action via a generative model based on the reward with the boost action as a state of the generative model, the next boost action comprising a second number of tasks among the plurality of tasks assigned to a respective one of the plurality of hosts.

In some embodiments, the method 800 may further comprise dispatching the second number of tasks to the respective one of the plurality of hosts based on the next boost action.

In some embodiments, determining the reward comprises: determining the reward based on the change in the task execution efficiency and a host resource utilization for the boost action via the discriminative model.

In some embodiments, the method 800 may further comprise determining whether a host resource utilization for the boost action is greater than a threshold; and in response to determining that the host resource utilization is greater than the threshold, determining the boost action to be an invalid boost action.

In some embodiments, the method 800 may further comprise determining a boost indicator that indicates whether the boost action is effective for the plurality of workloads.

In some embodiments, the boost indicator comprises at least one of: a number of workloads completed per unit time; and a difference between a resource scheduled by the boost action and an actual resource utilization.

In some embodiments, the method 800 may further comprise in response to determining from the boost indicator that the boost action is not effective, at least one of: stopping to dispatch one or more of the plurality of tasks to the plurality of hosts; and reclaiming the number of tasks dispatched to the plurality of hosts.

It should be noted that the processing of resource and workload scheduling according to embodiments of this disclosure could be implemented by computer system/server 12 of FIG. 1.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for workload scheduling, the method comprising:
determining, by one or more processors, a spare resource on each of a plurality of hosts for a plurality of workloads, each of the plurality of workloads comprising a plurality of tasks;
obtaining, by the one or more processors, an average resource consumption on the plurality of hosts based on a historical resource consumption associated with the plurality of workloads;
determining, by the one or more processors, a boost action based on the spare resource and the average resource consumption, the boost action comprising a number of tasks among the plurality of tasks assigned to a respective one of the plurality of hosts; and
dispatching, by the one or more processors, the number of tasks to the respective one of the plurality of hosts based on the boost action.

2. The method of claim 1, further comprising:
determining, by the one or more processors, a reward based on a change in a task execution efficiency after the boost action via a discriminative model; and
determining, by the one or more processors, a next boost action via a generative model based on the reward with the boost action as a state of the generative model, the next boost action comprising a second number of tasks among the plurality of tasks assigned to a respective one of the plurality of hosts.

3. The method of claim 2, further comprising:
dispatching, by the one or more processors, the second number of tasks to the respective one of the plurality of hosts based on the next boost action.

4. The method of claim 2, wherein determining the reward includes determining, by the one or more processors, the reward based on the change in the task execution efficiency and a host resource utilization for the boost action via the discriminative model.

5. The method of claim 1, further comprising:
determining, by the one or more processors, whether a host resource utilization for the boost action is greater than a threshold; and
in response to determining that the host resource utilization is greater than the threshold, determining, by the one or more processors, the boost action to be an invalid boost action.

6. The method of claim 1, further comprising:
determining, by the one or more processors, a boost indicator that indicates whether the boost action is effective for the plurality of workloads.

7. The method of claim 6, wherein the boost indicator comprises at least one of:
a number of workloads completed per unit time; and
a difference between a resource scheduled by the boost action and an actual resource utilization.

8. The method of claim 6, further comprising, in response to determining from the boost indicator that the boost action is not effective, at least one of:
stopping, by the one or more processors, to dispatch one or more of the plurality of tasks to the plurality of hosts; and
reclaiming, by the one or more processors, the number of tasks dispatched to the plurality of hosts.

9. A computer system for workload scheduling, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
determining a spare resource on each of a plurality of hosts for a plurality of workloads, wherein each of the plurality of workloads comprises a plurality of tasks;
obtaining an average resource consumption on the plurality of hosts based on a historical resource consumption associated with the plurality of workloads;
determining a boost action based on the spare resource and the average resource consumption, the boost action comprising a number of tasks among the plurality of tasks assigned to a respective one of the plurality of hosts; and
dispatching the number of tasks to the respective one of the plurality of hosts based on the boost action.

10. The computer system of claim 9, further comprising:
determining a reward based on a change in a task execution efficiency after the boost action via a discriminative model; and
determining a next boost action via a generative model based on the reward with the boost action as a state of the generative model, the next boost action comprising a second number of tasks among the plurality of tasks assigned to a respective one of the plurality of hosts.

11. The computer system of claim 10, further comprising:
dispatching the second number of tasks to the respective one of the plurality of hosts based on the next boost action.

12. The computer system of claim 10, wherein determining the reward comprises:
determining the reward based on the change in the task execution efficiency and a host resource utilization for the boost action via the discriminative model.

13. The computer system of claim 9, further comprising:
determining whether a host resource utilization for the boost action is greater than a threshold; and
in response to determining that the host resource utilization for the boost action is greater than the threshold, determining the boost action to be an invalid boost action.

14. The computer system of claim 9, further comprising:
determining a boost indicator that indicates whether the boost action is effective for the plurality of workloads.

15. The computer system of claim 14, wherein the boost indicator comprises at least one of:
a number of workloads completed per unit time; and
a difference between a resource scheduled by the boost action and an actual resource utilization.

16. The computer system of claim 14, further comprising:
in response to determining from the boost indicator that the boost action is not effective, at least one of:
stopping to dispatch one or more of the plurality of tasks to the plurality of hosts; and
reclaiming the number of tasks dispatched to the plurality of hosts.

17. A computer program product for workload scheduling, comprising:
one or more non-transitory computer-readable storage media and program instructions stored on at least one of the one or more tangible storage media, the program instructions executable by a processor to cause the processor to perform a method comprising:
determining a spare resource on each of a plurality of hosts for a plurality of workloads, each of the plurality of workloads comprising a plurality of tasks;
obtaining an average resource consumption on the plurality of hosts based on a historical resource consumption associated with the plurality of workloads;
determining a boost action based on the spare resource and the average resource consumption, the boost action comprising a number of tasks among the plurality of tasks assigned to a respective one of the plurality of hosts; and
dispatching the number of tasks to the respective one of the plurality of hosts based on the boost action.

18. The computer program product of claim 17, further comprising:
determining a reward based on a change in a task execution efficiency after the boost action via a discriminative model; and
determining a next boost action via a generative model based on the reward with the boost action as a state of the generative model, the next boost action comprising a second number of tasks among the plurality of tasks assigned to a respective one of the plurality of hosts.

19. The computer program product of claim 17, further comprising:
determining a boost indicator that indicates whether the boost action is effective for the plurality of workloads.

20. The computer program product of claim 19, further comprising:
in response to determining from the boost indicator that the boost action is not effective, at least one of:
stopping to dispatch one or more of the plurality of tasks to the plurality of hosts; and
reclaiming the number of tasks dispatched to the plurality of hosts.
